(19) United States
(12) Patent Application Publication
(10) Pub. No.: US 2024/0344956 A1
(43) Pub. Date: Oct. 17, 2024

(54) DEVICE AND METHOD FOR DETECTION OF PARTICLES USING A LINE LASER

(71) Applicant: Research Triangle Institute, Research Triangle Park, NC (US)

(72) Inventors: Anthony Clint Clayton, Rougemont, NC (US); Ryan Chartier, Fuquay Varina, NC (US); Jameson Holden, Chapel Hill, NC (US); Roger Pope, Efland, NC (US)

(21) Appl. No.: 18/631,969

(22) Filed: Apr. 10, 2024

Related U.S. Application Data
(60) Provisional application No. 63/495,438, filed on Apr. 11, 2023.

(51) Int. Cl. G01N 15/075; G01N 15/06

(52) U.S. Cl. CPC G01N 15/075; G01N 15/0618

(57) ABSTRACT

A particle detector system for particle analysis. The system has a detection chamber for introduction of a fluid stream having particles, a light source configured to irradiate the particles across a two-dimensional plane in the detection chamber. and a light detector configured to detect either light scattered by particles or light emitted from the particles.

### CROSS-REFERENCE TO RELATED APPLICATIONS

This application is related to and claims priority to U.S. Ser. No. 63/495,438 entitled “DEVICE AND METHOD FOR DETECTION OF PARTICLES USING A LINE LASER” filed Apr. 11, 2023, the contents of each of which are incorporated by reference herein in its entirety. This application is related to entitled to U.S. Pat. No. 11,047,787 entitled “DESIGN AND METHOD FOR OPTICAL BENCH FOR DETECTING PARTICLES” filed Apr. 29, 2020. This application is a related to U.S. patent application Ser. No. 15/048,199, now U.S. Pat. No. 9,915,600, filed Feb. 19, 2016, which is a continuation-in-part of International Application No. PCT/US2015/046076, filed Aug. 20, 2015, titled “DEVICES, SYSTEMS, AND METHODS FOR DETECTING PARTICLES,” which claims the benefit of U.S. Provisional Patent Application Ser. No. 62/039,512, filed Aug. 20, 2014, titled “DEVICES, SYSTEMS AND METHODS FOR DETECTING PARTICLES,” the contents of each of which are incorporated by reference herein in their entireties.

### TECHNICAL FIELD

The present invention relates to a system for optical-based detection of particles in an aerosol or liquid, including measurement of light scattering and autofluorescence.

### BACKGROUND

Detection of particles and colloids suspended in a fluid medium for measurement of concentration or other properties is useful in a variety of applications such as medical diagnostics, scientific research, air quality measurements, and threat detection. Examples include measurement of the concentration of particles suspended in a liquid such as proteins in blood, and airborne particles in inside environments such as building as well as outside environments.

One application of note is the measurement of the concentration and other properties of airborne particles (or particulate matter, PM) in aerosols. The United States Environmental Protection Agency (US EPA) has set exposure standards for coarse PM (between 10 μm and 2.5 μm, PM₁₀) and fine PM (less than 2.5 μm, PM_{2.5}) due to the importance of aerosol concentration in the air and its health effects. Aerosol concentrations are also important in the manufacturing industry for both protection of the health of workers and preventing contamination in the manufacturing process.

A class of aerosols of special interest is bioaerosols. Bioaerosols include bio-particles such as fungus spores, bacteria spores, bacteria, viruses, and biologically derived particles (skin cells, detritus, etc.). Some bioaerosols cause chronic and/or acute health effects, for example certain strains of black mold or Bacillus anthraces (causative bacteria of anthrax). Bioaerosol concentrations are important in maintaining safe hospitals, clean food processing, pharmaceutical and medical device manufacturing, and air quality. Airborne spread of diseases is of particular concern from a public health perspective. Aerosolized bioagents can also be used by terrorists to harm civilian or military populations.

Measurement (sensing) of aerosol and bioaerosol concentration is typically accomplished with optical techniques. Aerosol (e.g., solid and liquid particles≤10 μm dispersed in air) concentration measurement is readily achieved by various light scattering measurements. See Hinds, Aerosol Technology, New York, John Wiley & Sons, Inc. (1982); Lehtimaki and Willeke, Measurement Methods, Aerosol Measurement, Willeke and Baron, New York, Van Norstrand Reinhold, 112-129 (1993). The most accurate method entails the use of a single particle counter that focuses a stream of aerosol into a detection cavity where light scattering from a long wavelength (>650 nm) laser is measured. Precision optics are required to collect and focus the scattered light (while excluding the source light) onto a photon detector. The photon detectors are made from silicon or photocathode materials (e.g., indium gallium arsenide) that undergo the photoelectric effect (convert photons to electrons). These materials are packaged into detectors that offer high amplification of the signal from the photons, such as photomultiplier tubes (PMTs) and avalanche photodiodes (APDs). These detectors have active detection areas that are small (less than 25 mm²) and limited to planar geometries. Moreover, these detectors cost $100 or more, often exceeding $1,000 in the case of a high sensitivity PMT.

Autofluorescence (or intrinsic fluorescence) excited by ultraviolet (UV) and blue light is well-developed for detection of bioaerosols. See Hairston et al., “Design of an instrument for real-time detection of bioaerosols using simultaneous measurement of particle aerodynamic size and intrinsic fluorescence,” Journal of Aerosol Science 28 (3): 471-482 (1997); Ho, “Future of biological aerosol detection,” Analytical Chimica Acta 457 (1): 125-148 (2002); Agranovski et al., “Real-time measurement of bacterial aerosols with the UVAPS: Performance evaluation,” Journal of Aerosol Science 34 (3): 301-317 (2003); Ammor, “Recent advances in the use of intrinsic fluorescence for bacterial identification and characterization,” Journal of Fluorescence 17 (5): 455-459 (2007); Ho et al., “Feasability of using real-time optical methods for detecting the presence of viable bacteria aerosols at low concentrations in clean room environments,” Aerobiologia 27 (2): 163-172 (2011). Exploiting autofluorescence of microbes is widely viewed as one of the most cost-effective means to detect a potential biological threat. Bioaerosol detectors typically use a combination of light scattering (measurement of general aerosol concentration and properties) and autofluorescence (detection of emitted photons). Bioaerosol detectors based on autofluorescence rely on fluorescence from molecular fluorophores that reside within the bio-particle. For clean bio-particles, this fluorescence can be primarily attributed to biochemicals such as tryptophan and tyrosine (amino acids), nicotinamide adenine dinucleotide (NADH), and riboflavin. NADH and riboflavin absorb and emit longer wavelengths than the amino acids. See Jeys et al., “Advanced trigger development,” Lincon Laboratory Journal 17 (1): 29-62 (2007); Hill et al., “Fluorescence of bioaerosols: mathematical model including primary fluorescing and absorbing molecules in bacteria,” Optics Express 21 (19): 22285-22313 (2013). The ability to use longer wavelength excitation sources such as light-emitting diodes (LEDs, excitation wavelength λ_{exc}>360 nm) or lasers (λₑₓₑ>400 nm) may reduce the cost of such instruments.

Traditional bioaerosol particle detectors rely on three main components: (1) an excitation source of appropriate wavelength to excite a targeted fluorophore or collection of fluorophores; (2) precision optics (lenses and mirrors) on both the excitation and emission side to focus the source onto the narrow air stream and to enhance the collection of emitted photons from biological particles; and (3) a high gain detector such as a PMT or APD. Elastic light scattering from visible or long wavelengths is utilized to count and sometimes size the particles. Autofluorescence of biomolecules is utilized to detect microorganisms. The typical bioaerosol detector utilizes a small detection cavity, with fluorescence active volumes on the order of 1×10⁻⁴ cm³, making the window for detection of each bioaerosol particle exceedingly small. At typical flow rates, a bioaerosol particle resides within the excitation volume for 1-10 μs on average. See Hairston et al. (1997). As a result, emitted and scattered light from each bioaerosol particle is collected virtually on an individual basis, and the signal is weak. See Greenwood et al., “Optical Techniques for Detecting and Identifying Biological Warfare Agents,” Proceedings of the IEEE 97 (6): 971-989 (2009). This weak signal thus requires the use of precision lenses and mirrors to collect the weak signal and focus it onto the high gain detector (e.g., PMT or APD).

Measurement of aerosol and bioaerosol concentration and changes in concentration is possible via a variety of commercially available instruments such as the Laser Aerosol Spectrometer for aerosols (TSI Incorporated, Shoreview, Minnesota, USA), the Ultraviolet Aerodynamic Particle Sizer for bioaerosols (TSI Incorporated), the Wideband Integrated Bioaerosol Sensor (WIBS-4) for bioaerosols (Droplet Measurement Technologies, Boulder, Colorado, USA), and the instantaneous biological analyzer and collector (FLIR Systems, Inc., Wilsonville, Oregon, USA). However, such instruments can exceed $10,000 in cost making wide spread use cost prohibitive. Furthermore, having a sufficiently dense sensor network of aerosol/bioaerosol sensors (i.e., multiples of these instruments in communication with a central network) is cost prohibitive. The high cost of a sensor network also means that capitalizing on responsive systems is challenging. For example, it would be desirable to provide several bioaerosol sensors positioned throughout a hospital or other building and networked with the building's control systems to maintain a safe environment and respond to a change in bioaerosol concentration, such as by diverting airflow or indicating the need for maintenance of filters and air handlers.

Aerosol exposure monitors have been developed that acquire data from aerosol while the aerosol is sampled in real time during a prescribed sampling period (integration period). Such devices may employ inertial impactors for aerodynamic sizing, particle collection filters for collection and subsequent analysis, and nephelometers for measuring particle concentration by acquiring light scattering data in real time. Examples of such devices are described in International Publication No. WO 2013/063426, filed Oct. 26, 2012, titled “AEROSOL EXPOSURE MONITORING,” the content of which is incorporated by reference herein in its entirety. Also known are turbidometers, which measure the concentrations of particles such as cells in solution.

U.S. Pat. No. 5,686,996 (the entire contents of which are incorporated herein by reference) describes a device for aligning a laser. The device consists of a rigid member with alignment marks which define the intended point of impingement of a beam emitted from the laser. The laser is moved to allow the emitted laser beam to extend upon the alignment device and impinge upon the alignment marks. When the laser beam impinges upon alignment marks, preferably formed near the center of the alignment device, the laser is determined to be in proper alignment.

U.S. Pat. No. 7,511,258 (the entire contents of which are incorporated herein by reference) describes an optical package having a top and bottom orientation. This package included (a) a platform defining a V-groove with walls of a certain pitch; (b) a first optical component having a reference surface and two sides, each side being beveled at the certain pitch outwardly from the reference surface, the first optical component having a first optical axis, the first optical component being disposed in the V-groove such that the reference surface faces downward and the sides are in parallel contact with the walls of the V-groove; and (c) a second optical component having an outer periphery with at least two contact points and a second optical axis, the second optical component being disposed in the V-groove such that the contact points contact the walls of the V-groove and the second optical axis is coaxial with the first optical axis.

U.S. Pat. No. 6,909,269 (the entire contents of which are incorporated herein by reference) describes a particle detector including first and second cells, the first cell supplying a liquid containing particles to the second cell; electrodes respectively provided in the first cell and the second cell; a plurality of shafts; and clamp members engaged with the respective shafts; the first cell and the second cell being arranged in alignment with each other; the shafts extending through the first cell and the second cell along the alignment of the first cell and the second cell; the clamp members clamping the first cell and the second cell along the alignment

U.S. Pat. No. 7,436,515 (the entire contents of which are incorporated herein by reference) describes a method and apparatus for the analysis of fluid borne particles and which is especially suitable for the detection of airborne biological particles. The apparatus for the detection of fluid borne particles includes a zone through which a fluid to be analyzed flows in use, a source of illumination to illuminate/irradiate fluid borne particles present in said zone, and a detector to detect light from the particles as an indicator of the presence or characteristics of the particles, wherein the apparatus comprises an integrating sphere and the zone is within the integrating sphere.

U.S. Pat. No. 9,772,278 (the entire contents of which are incorporated herein by reference) describes a multi-channel aerosol scattering absorption measuring instrument, comprising a light path device, a detection device and a gas path device. The light path device supplies three different wavelengths of laser entering the detection device in sequence; the detection device is provided with photoelectric detectors at multiple angles for measurement, so as to reduce the measurement error of aerosol scattering coefficient; the gas path device comprises a sample loading unit, a calibration unit and a sample discharging unit; and a light source from the light path device and a gas flow from the gas path device enter the photoacoustic cavity of the detection device respectively and are detected by a control unit.

U.S. Pat. Apl. Publ. No. 20170268980 (the entire contents of which are incorporated herein by reference) describes sample monitoring and flow control systems and methods for monitoring of airborne particulates. A system may include a particle collection filter. The system also includes a fluid moving device for moving a sample through the particle collection filter. Further, the system includes a light source configured to direct irradiating light towards the particle collection filter. The system also includes a light detector positioned to receive the irradiating light passing through the particle collection filter and configured to generate a signal representative of an amount of the received light. Further, the system includes a controller configured to receive the signal and to control the fluid moving device based on the amount of the received light.

Portable Laser Aerosol Spectrometer and Dust Monitor Model 1.108/1.109, 2010 (the entire contents of which are incorporated herein by reference) describes a dust aerosol spectrometer and dust monitors that are compact, portable, and continuously measure airborne particles and particle count distribution using an integrated gravimetric filter on which the particles are collected for further analysis after optical measurement. The measuring principle is the light scattering of single particles using a semiconductor laser as a light source. Inside the measuring cell, the scattering light is led directly and via a mirror with a wide opening angle onto the detector. The detector is positioned at a right angle to the incident laser beam. This optical alignment increases the scattering light collected by the detector and optimizes the signal-to-noise ratio. Therefore, even very small particles down to 0.25 μm respectively 0.3 μm can be detected.

### SUMMARY

According to one embodiment, there is provided a particle detector system for particle analysis. The system has a detection chamber for introduction of a fluid stream having particles, a light source configured to irradiate the particles across a two-dimensional plane in the detection chamber. and a light detector configured to detect either light scattered by particles or light emitted from the particles.

According to another embodiment, a method for analyzing particles is provided. The method introduces a fluid stream with particles entrained therein into a detection chamber, irradiates the particles in the fluid stream across a two-dimensional plane in the detection chamber, and measures by a light detector either light scattered by particles or light emitted from the particles.

According to another embodiment, a system for analyzing particles in a fluid stream, is provided. The system includes means for irradiating particles in a fluid stream across a two-dimensional plane, and means for measuring light scattering or autofluorescence from the particles in the fluid stream.

According to another embodiment, a detection chamber for analyzing particles is provided. The detection chamber has a light source configured to irradiate across a two-dimensional plane in the detection chamber and has a light detector configured to measure either light scattered by or light emitted from particles in a fluid stream in the two-dimensional plane.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a top-down view a particle detector system according to one embodiment of the invention.

FIG. 2 is a perspective view of detection chamber 104 showing one configuration for implementing the constructs of FIG. 1.

FIG. 3 is a depiction of one embodiment of the particle detector system of the present disclosure.

FIG. 4 is a depiction of another embodiment of the particle detector system of the present disclosure.

FIG. 5 is a depiction of still another embodiment of the particle detector system of the present disclosure.

FIG. 6 is a depiction of yet another embodiment of the particle detector system of the present disclosure.

FIG. 7 is a graph showing scattered light intensity measured at four (4) different particle concentrations in an aerosol stream.

FIG. 8 is a graph showing scattered light measured intensity measured after introduction of aerosol in active particle system APS having an aerosol stream forced through and in a passive (drone) particle detector where an aerosol stream enters the particle detector by motion of the particle detector.

FIG. 9 is a flow chart depicting one method embodiment of the present disclosure for analyzing particles in a fluid stream.

### DETAILED DESCRIPTION

As used herein, the term “aerosol” generally refers to an assembly of liquid or solid particles (or particulates, or particulate matter) suspended in a gaseous medium long enough to be observed and measured. The size of aerosol particles typically ranges from about 0.001 μm to about 100 μm. See Kulkarni et al., Aerosol Measurement, 3^{rd} ed., John Wiley & Sons, Inc. (2011), p. 821. The term “gaseous fluid” generally refers to a gas (or gaseous fluid, or gas-phase fluid). A gas may or may not contain liquid droplets or vapor, and may or may not contain aerosol particles. An example of a gas is, but is not limited to, ambient air. An aerosol may thus be considered as comprising particles and a gas that entrains or carries the particles.

As used herein, the term “bioaerosol” generally refers to an aerosol in which one or more bio-particles are suspended or carried. The term “bio-particle” generally refers to a biological material, or the combination of a biological material and a non-biological particle on which the biological material is carried. That is, a biological material may itself be a particle freely suspended in an aerosol, or may be carried on a non-biological particle such that the biological material and the non-biological particle are suspended together in the aerosol. The biological material may be carried on the non-biological particle by any mechanism such as, for example, entrapment, embedment, adhesion, adsorption, attractive force, affinity, etc. Examples of biological materials include, but are not limited to, spores (e.g., fungal spores, bacterial spores, etc.), fungi, molds, bacteria, viruses, biological cells or intracellular components, biologically derived particles (e.g., skin cells, detritus, etc.), etc.

As used herein, for convenience the term “aerosol” generally encompasses the term “bioaerosol” and the term “particle” generally encompasses the term “bio-particle,” unless indicated otherwise or the context dictates otherwise.

As used herein, the term “fluid” generally encompasses the term “liquid” as well as the term “gas,” unless indicated otherwise or the context dictates otherwise. Particles suspended or carried in a liquid, as well as particles suspended or carried in an aerosol, may be detected by devices and methods disclosed herein.

As used herein, the term “light” generally refers to electromagnetic radiation, quantizable as photons. As it pertains to the present disclosure, light may propagate at wavelengths ranging from ultraviolet (UV) to infrared (IR). In the present disclosure, the terms “light,” “photons,” and “radiation” are used interchangeably.

As used herein, a material is “optically transparent” if it is able to efficiently pass (with minimal optical transmission loss) light of a desired wavelength or range of wavelengths.

The present invention arises out of the context of existing particle/aeorsol detection technologies where the instruments with better sensitivity are usually too large and bulky to be considered for wearable or portable use. On the other hand, the smaller detectors suffer from detection levels that are too low for sensitive use applications. One embodiment of the invention provides (for a fixed sampling space) a wider area of detection (and an optional larger detector) to be used when a planar or flat geometry light source is used, thereby improving sensitivity for smaller, wearable detectors.

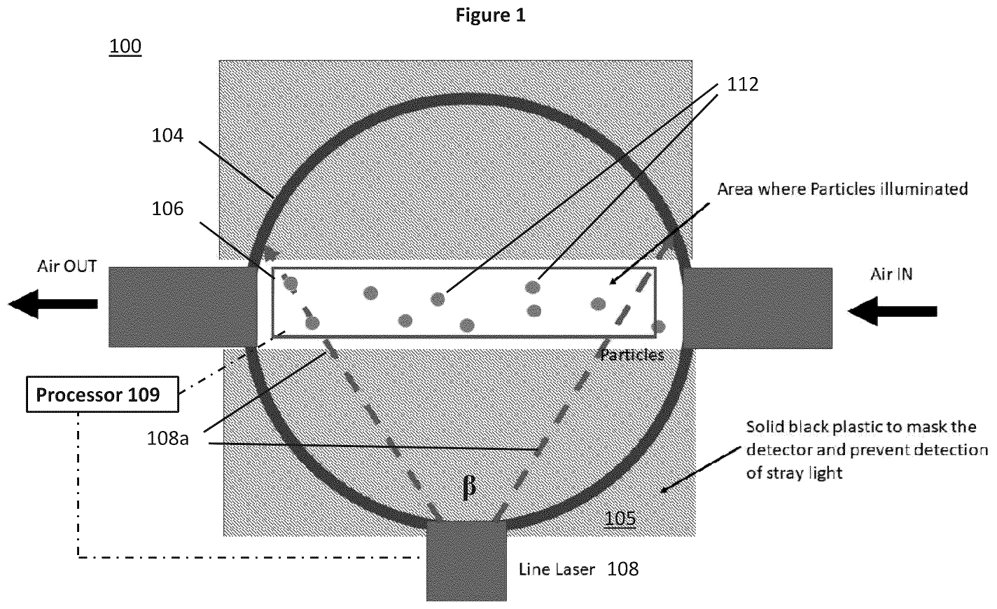

FIG. 1 is a top-down view a particle detector 100 according to one embodiment of the invention. Particle detector 100 has a) a detection chamber 104 (or sample volume) through which a particle-laden sample fluid (i.e., aerosol or liquid) may flow and b) a light source 108 illustrated in FIG. 1 as a line laser 108. In the top-down view of FIG. 1, the detection chamber 104 is disposed above an optical absorption base 105 (depicted in the example here as a solid black plastic). In general, light source 108 produces beams 108a of irradiating light of one or more selected wavelengths, which are directed into the detection chamber 104 to interact with particles 112 in the detection chamber 104. The particles 112 are contained in a fluid such as the example of “air in” and “air out” shown in FIG. 1. Detector 106 (e.g., underneath the area where particles are illuminated) collects (receives) measurement light (or emission light) from the particles 112 in response to the irradiation in a two-dimensional plane across the detection chamber 104. With more particularity, in one embodiment of the present disclosure, the light source 108 illuminates (by one or more beams 108a) an angular sector β of the detection chamber 104 through which particles 112 flow. The angular sector β (in one embodiment) ranges from 30 to 90°. The angular sector β (in another embodiment) ranges from 40 to 80°. The angular sector β (in another embodiment) ranges from 50 to 60°.

In one embodiment of the present disclosure, the light source 108 comprises a line laser where beams 108a are directed across the incoming particle-laden sample fluid (e.g., aerosol stream) to illuminate a fan-type area defined by the angular sector β inide detection chamber 104. In one embodiment of the present disclosure, the detector 106 comprises a large area type detector having a flat, planar geometry which captures a majority of the measurement light. In one embodiment of the present disclosure, the line laser is oriented perpendicularly to the aerosol flow to maximize the area of particle illumination. Combined with a large area detector, this configuration can maximize the sensitivity of particle detector 100 while keeping the overall product small and thin.

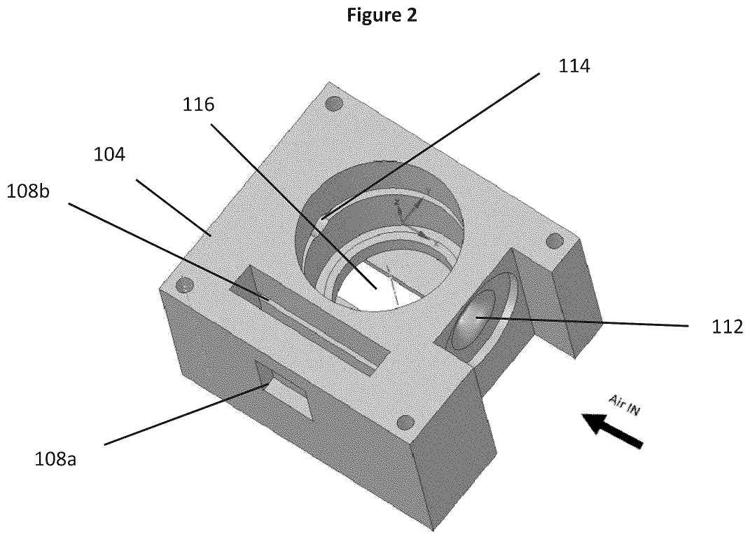

FIG. 2 is a perspective view of detection chamber 104 showing one configuration for implementing the constructs of FIG. 1. In this embodiment of the present disclosure, detection chamber 104 include a light source aperture 108a into which light source 108 or a head of a light source or a fiber optic from a light source would fit. FIG. 2 shows a cut-out slit 108b formed along an interior wall of detection chamber 104 to define an optical aperture. FIG. 2 shows a fluid flow entry port 112 and a fluid flow exit port 114 formed in the detection chamber 104. FIG. 2 shows a detector aperture 116 at the base of the detection chamber 104. A large-area detector would be configured to detect light emanating through the detector aperture 116.

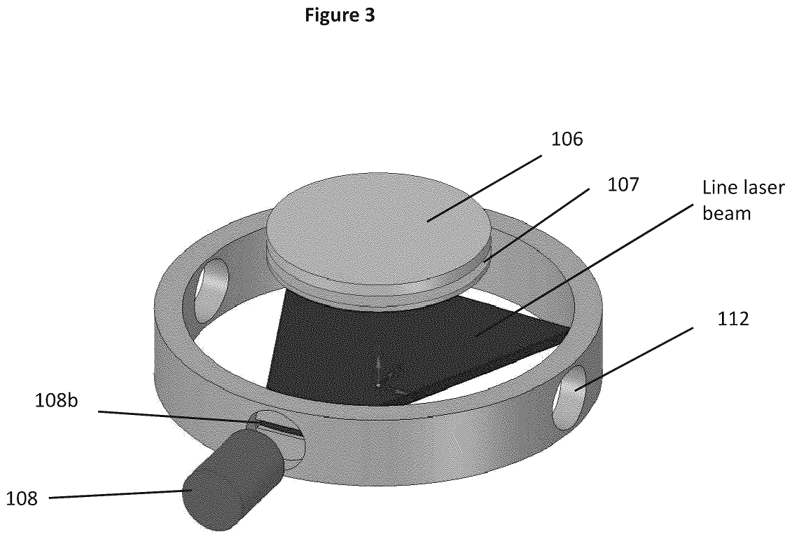

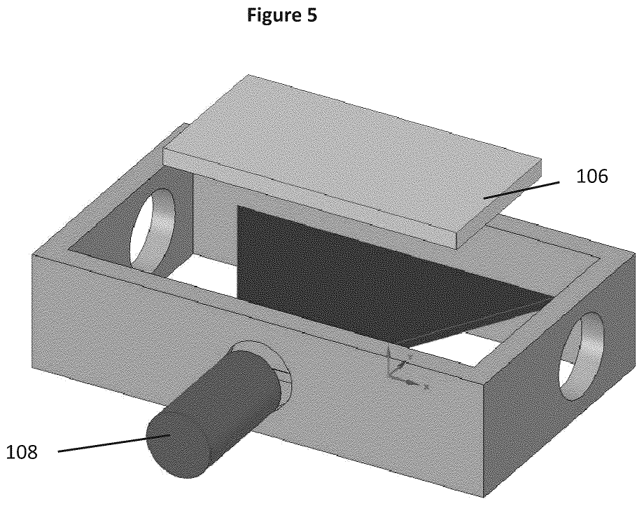

FIGS. 3-6 are depictions of various embodiments of the particle detector 100 of the present disclosure. FIGS. 3-6 show cut-away versions of the detection area. These drawings represent an inner exploded view of the particle detector 100. The drawings show that the invention is not limited to a round or circular detection area, and can be represented in a square or rectangle, or even triangular geometries. Air flow is preferred, but not limited to a specific inlet and outlet, and may also be provided passively by movement of the detection device through sampling environment.

In one embodiment of the present disclosure, the detector 106 comprises a light sensor disposed above or below the detection chamber 104. In one embodiment, the detector 106 comprises multiple light sensors disposed above and below the detection chamber 104. In one embodiment, the detector 106 comprises multiple light sensors disposed at different positions around the detection chamber 104.

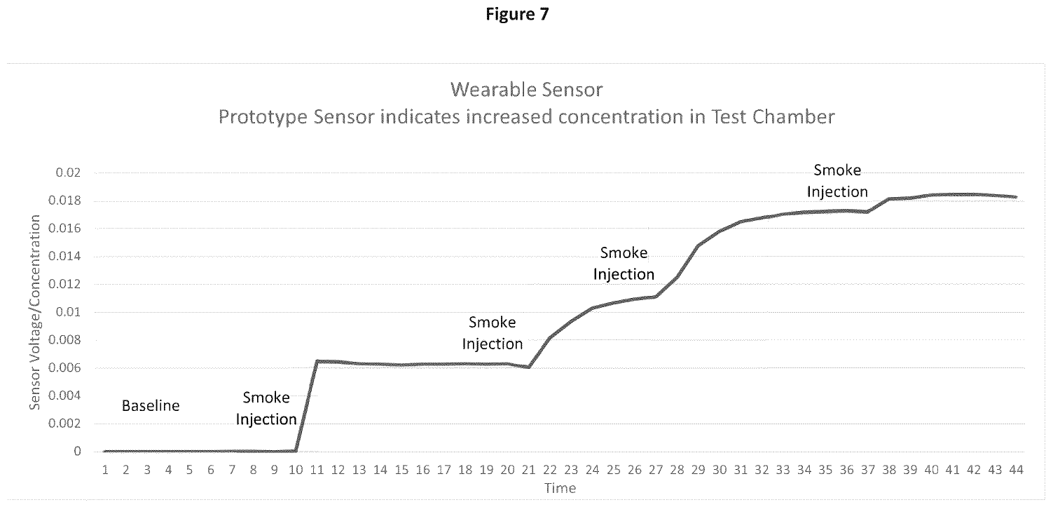

In one embodiment of the present disclosure, particle detector 100 is operated to acquire particle data in real time as sample fluid flows through the particle detector 100. FIG. 7 is a graph showing scattered light intensity measured at four (4) different particle concentrations in an aerosol stream. The results demonstrate the efficacy of the present particle detection system.

In the present context, “irradiating” light refers to the light produced by a light source and utilized to irradiate particles in a detection cavity, as distinguished from measurement light and as also distinguished from background light (i.e., non-analytical light that would only contribute to background signal noise, such as ambient light). In the present context, “measurement” light refers to the light scattered or otherwise emitted from the particles in response to the irradiation. For example, measurement light may be light scattered (reflected) from the particles or fluorescent light emitted from the particles. The particle detectors (discussed herein) may be configured for measuring scattered light and/or fluorescently emitted light. The particle detector (discussed herein) may be configured for measuring scattered light and fluorescently emitted light simultaneously or sequentially.

As regards scattered light, the particle detectors (discussed herein) may be configured in particular for measuring elastically scattered light. Irradiating light incident on a particle may be elastically scattered from the particle at the same wavelength as the irradiating light, in accordance with the particle's size and shape and the difference in the index of refraction of the particle and that of the sample fluid. The scattering mode may be Rayleigh scattering, Mie scattering, or geometric scattering, depending on the size of the particle relative to the wavelength of the irradiating light. As regards fluorescently emitted light, the irradiating light may be utilized as an excitation light for inducing autofluorescence in the fluorophores of a particle (particularly a bio-particle). That is, irradiating light of an appropriate wavelength or wavelength range incident on a fluorophore-containing particle may be absorbed by the particle and thereby induce the particle to fluoresce, i.e., emit light at a different (typically longer) wavelength or wavelength range. Generally, measurement light may propagate from an irradiated particle in any of a large number of directions.

In some embodiments, walls of the detection chamber 104, may be composed of a low reflectance material, or at least an inside surface of the detection chamber 104 may be composed of a low reflectance (or opaque, or anti-reflective) material, useful in preventing stray light from reaching the light detector 108.

In some embodiments, the irradiating wavelength is in a range from 250 to 1500 nm. In various embodiments, the irradiating wavelength may be in the ultraviolet range, the visible range, or the infrared range. For measuring scattered light, the light source 108 may be selected based on factors such as low cost, emission at an irradiating wavelength that does not induce autofluorescence, etc. For measuring fluorescent emission, the light source 108 may be selected based on irradiating wavelength needed to excite certain bio-particles of interest. In some embodiments, longer irradiating wavelengths may be utilized for detecting scattered radiation while shorter irradiating wavelengths may be utilized for exciting fluorophores. For example, visible to long wavelengths such as violet (e.g., 405 nm) to infrared (IR, e.g., 900 nm) may be utilized for detecting scattered radiation, with red (e.g., 650 nm) to near IR wavelengths being typical in some embodiments. As another example, ultraviolet (UV) to blue wavelengths (e.g., 365 to 450 nm) may be utilized for exciting fluorophores. The TABLE below provides ground and excited-state properties of a few biologically relevant fluorophores, nicotinamide adenine dinucleotide (NADH) and riboflavin, as well as an experimental surrogate, 2% Tinopal-on-Syloid, which is Syloid® silica powder (W.R. Grace and Company, Columbia, Maryland, USA) tagged with 2% Tinopal® CBS X florophore (BASF, Florham Park, New Jersey, USA).

TABLE

| | Total | | | | | |
|---|---|---|---|---|---|---|
| | Fluorophores | Extinction | | Emission | Quantum | |
| | Per Particle, | Coefficient, | Absorbance | Spectral | Yield for | Fluorescence |
| Fluorophore | (#/particle) | (M⁻¹ cm⁻¹) | Onset (nm) | Range | Fluorescence | Lifetime (ns) |
| 2% Tinopal- | 1.5 × 10⁷ | 1,000 | <420 | 380-575 | 0.81 | 1.2 |
| on-Syloid | | | | | | |
| Free NADH | 4.8 × 10⁶ | 6,220 | <410 | 390-510 | 0.020 (0.08) | 0.38, 0.74 |
| (protein- | | | | | | (1.2) |
| bound NADH) | | | | | | |
| Riboflavin | 2 × 10⁶ | 15,000 | <500 | 480-610 | 0.3 | 4.1 |

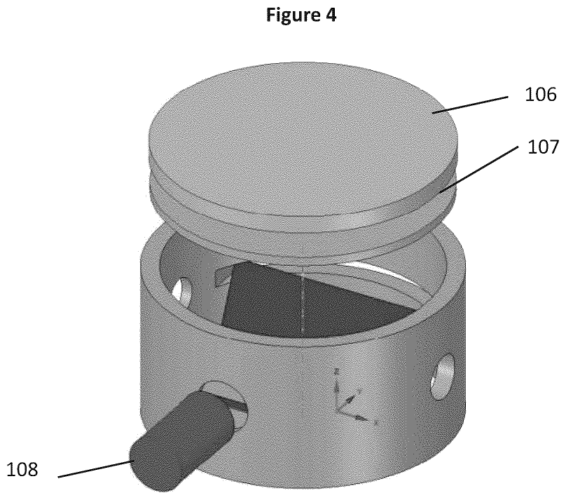

In some embodiments, the particle detector 106 may include a light trap. The light trap may be positioned in optical alignment with the light source, on the opposite side of the detection cavity as the light source. Generally, a light trap may have any configuration suitable for effectively absorbing light and preventing light from being reflected back into the particle detector. Various configurations for light traps are known to persons skilled in the art. A light trap may include a plate or cavity that is opaque (“optically black”) or anti-reflective, or at least the surface(s) of such plate or cavity facing the detection cavity (or coating on the surface) is opaque or anti-reflective. A light trap may include geometries or structures configured for trapping or otherwise absorbing light. Referring back to FIG. 4, FIG. 4 actually shows a slit in the back side that is for this exact purpose of light trapping. A wide slit similar in size to the line laser beam dimensions represents one light trap embodiment. Other light trap embodiments include for example anti-reflective materials used stand-alone or in combination with a slit. A trap area compartment may also be used.

In some embodiments, if needed or desired, the particle detector 100 may include a device (one or more components) configured for preventing stray light from impinging on the light detector 106. Generally, stray light is any light having no analytical value such that measurement of the light by the light detector 106 is undesired. Stray light elevates the detector output signal produced by the light detector 106 even in the absence of particles in the detection cavity, and thus may contribute to a large background (or baseline) signal that lowers the signal-to-noise (S/N) ratio of the particle detector 100, and may also convolute the measurement data. Here, in one embodiment of the present disclosure, the detection chamber 104 comprises an opaque material for absorbing incident light in order to reduce noise in the light detector 106.

In some embodiments, if needed or desired, the particle detector 106 or light source 108 may include beam shaping optics. The beam shaping optics may include one or more optics components (e.g., lenses). In the present context, the term “beam shaping optics” refers to an optical component that modifies a light beam or beam path without filtering out wavelengths.

In some embodiments, the light detector 106 is configured for collecting measurement light over a large detection area (i.e., a large photon collection area) via a plurality of paths. To this end, the light detector 106 may include a large-area active photo-responsive or photo-sensitive material (e.g., a photovoltaic material, photoelectric material, photoconductive material, photoresistive material, etc.). The light detector 106 may also include one or more anodes and cathodes turning light into electrons and thereafter amplifying the electric current.

In some embodiments, the photo-responsive material is a photovoltaic (PV) material that produces both a current response and a voltage response to photons incident on its surface. For low light conditions, both a current response and voltage response are observed and are proportional to the amount of photons striking the PV material. The open-circuit voltage (OCV) of a PV material may show a measurable response to low-level particulate concentration changes (e.g., less than 100 #/cm³), due to the logarithmic response relationship between increases in low-level incident light (<<0.1 Suns; or the amount of incident photons corresponding to elastic scattering from particles or fluorescence emissions) and the resulting increase in OCV.

In all such embodiments, the photo-responsive material 1078 provides a very large number of detection points surrounding the detection cavity 104 on which photons of the measurement light may be incident and thereby detected and measured. These detection points may be located at different angular positions relative to the central axis (over dimension D in FIG. 10) and/or different axial positions relative to the longitudinal axis (over dimension L in FIG. 10). As evident from FIGS. 2 and 3, the photo-responsive material 1078 provides a target for measurement light propagating over many different paths from an irradiated particle. By this configuration, the light detector 1028 is able to output an electrical detector signal of relatively high intensity measurement even though individual optical measurement signals emanating from the particles may be relatively weak.

Referring back to FIGS. 1 and 3, in some embodiments the particle detector 106 further includes one or more optical filters such as optical filter 107 shown in FIG. 3. The optical filter generally may be configured to block one or more ranges of wavelengths, and thus may be a low-pass, high-pass, or band-pass filter. The optical filter may be a composite of two or more optical filters to obtain the desired pass/block characteristics. The optical filter may be a solid (e.g. glass or polymer) or gel (e.g. polymer) material, and may be thin and/or pliable enough to be flexible so as to conformally cover the photo-responsive material.

The optical filter (such as optical filter 107) may generally be configured for blocking any selected wavelength or range(s) of wavelengths (undesired photons), depending on the application. For example, when measuring autofluorescence, the optical filter may be configured for passing the wavelengths of the fluorescent measurement light while blocking the wavelength of the irradiating light utilized to excite the fluorophores. As another example, when measuring scattering, the optical filter may be configured for passing the wavelength of the irradiating light (and thus the wavelength of the scattered measurement light) while blocking other wavelengths such as, for example, stray ambient light.

Referring again to FIG. 1, in some embodiments the particle detector 100 may further include a data acquisition device such as processor 190 that may be placed in signal communication with the light detector 106. Processor 190 may be configured for measuring a response of the photo-responsive material (e.g., a voltage response, a current response, and/or resistance response), as embodied in an electrical detector signal outputted by the photo-responsive material. Processor 190 may be configured for converting the analog detector signal to a digital detector signal, and recording or storing the detector signal. Processor 190 may be configured for correlating the measurement of the response with one or more properties of the particles interrogated by the irradiation light in the detection chamber 104, such as particle size, concentration, identification (e.g., a certain type of bio-particle), etc. Processor 190 may be configured for performing any post-acquisition signal conditioning or processing required or desired, such as amplification, calibration, deconvolution, formatting for transmission to another device, etc. Processor 190 may be configured for generating data relating to one or more properties of the interrogated particles, and transmitting the data to another device (e.g., a computing device) via a wired or wireless communication link, or to one or more devices via a suitable communication network.

Processor 90 can be removably coupled to the light detector 108 such as by removable connections made with electrical leads from the photo-responsive material. As appreciated by persons skilled in the art, various functions of processor 190 may be implemented by hardware (or firmware), software, or both. Processor 190 may include one or more processors, memories, and other hardware. In one non-limiting example, processor 190 may be a 16-bit data logging device commercially available from Measurement Computing Corp., Norton, Massachusetts, USA (e.g., model USB-1698FS-Plus).

In one embodiment of the present disclosure, particle detector 100 can be used to detect smoke or other aerosol particles. In one embodiment of the present disclosure, particle detector 100 can be used as a wearable sensor which can monitor the environment of first responders and fire fighters during the entire span of their exposure. By choice of laser wavelength and/or having light filters, a biological related sensor can be obtained where for example a red laser at 632 nm or a 405 nm laser diode could be used. In one embodiment of the present disclosure, particle detector 100 includes components for wireless communication to sites remote from the particle detector 100 itself. For example, the “aerosol quality” of air inside a building could be monitored by multiple particle detectors 100 mounted at positions throughout a building such at entrances, cold-air returns, AC/heating ducts, kitchens, etc.

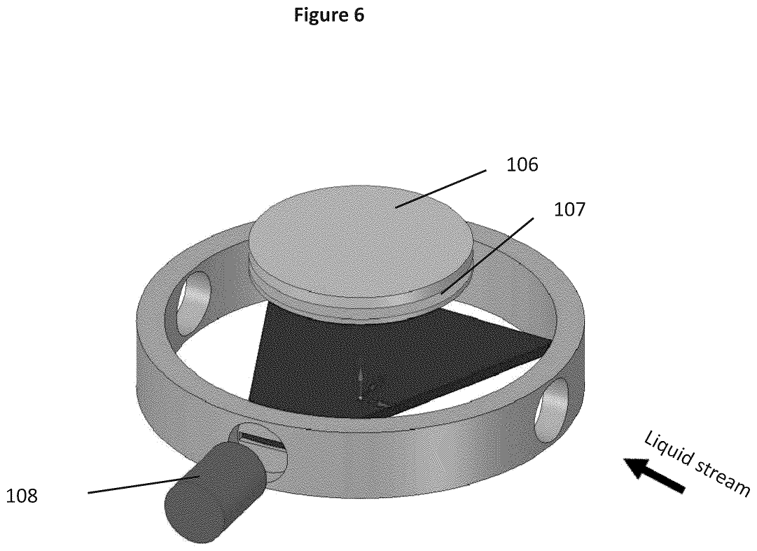

In some embodiments, particle detector 100 measures particles in a fluid gas stream, where the particles in the gas stream may be aerosol particles such as smoke or other toxic particles. In other embodiments, particle detector 100 can be used to detect particles in a liquid fluid stream. In this case, particle detector 100 could be immersed in a liquid fluid stream, as shown in FIG. 6. The liquid fluid stream may contain for example bacterial and/or viral particles and/or waste water particles and/or solids in a fluid after water filtration. These particles and/or solids in the liquid fluid stream would scatter light toward detector 106.

Multi-Channel sensor. In one embodiment, scattered light from particles 112 can be measure from multiple locations within the planer sensor, including from the “Top” and/or the “Bottom,” e.g., both perpendicular to the plane of incident light. This iteration can include a single top and bottom detector, or an array of multiple detectors (e.g., photodiodes). These detectors can have optical filters applied to them to measure scattered light at discrete wavelength ranges. Additionally, optical detectors can be located directly opposite the light source 108 and measure light extinction/absorption of the incident light through the particles at high concentrations for example in a range 10 to 10000 particles per cm³ or even higher. The detector 106 can be a single sensor, or an array of sensors in a linear arrangement to take advantage of the wide beam from the line laser.

Such a multi-channel sensor can utilize linear light sources with an array of wavelengths. Blue or UV wavelengths may be used to support autofluorescence detection from biological aerosols. This arrangement would require multiple detectors, with a least one detector having an optical filter in place to block detection of elastically scattered light. Autofluorescence would be measured at a longer wavelength than the incident light.

Passive Sampling. The planar sensor can be designed so it does not require an active air mover. If the sensor is worn by a person or mounted to an inanimate moving object (e.g., car, drone, etc.) the motion of the device can generate the air flow needed for the sample containing particulates to enter, transit, and exit the particle sensing device.

Drone-Mountable. The planar sensor can be configured so that it is small and light enough to be easily mounted to a drone, with limited payload capacity, for assessing air quality or plume/source tracking. The sensor can communicate wirelessly with the pilot while also storing data internally for off-line analysis. In some embodiments, particle detector 100 can be used to detect particles with a processor (e.g., processor 109 in FIG. 1) for communicating results from the light detector to a remote site. For example, the detection chamber may be one component of a drone. In another example, the detection chamber may be one component of a network of sensors distributed for example throughout a building communicating to a central monitoring station.

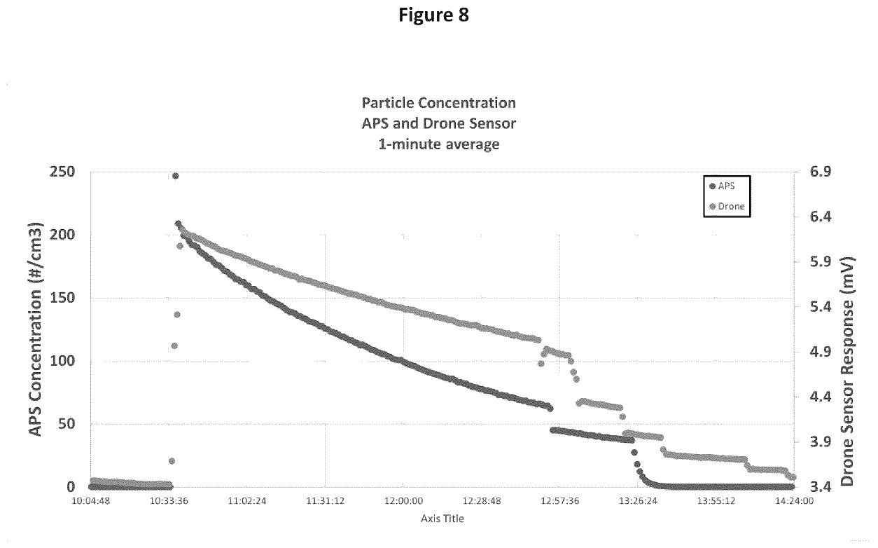

FIG. 8 is a graph showing scattered light measured intensity measured after active-sampling of an APS and in a passive-sampling (drone) particle detector where an aerosol stream flows through the particle detector by motion of the particle detector.

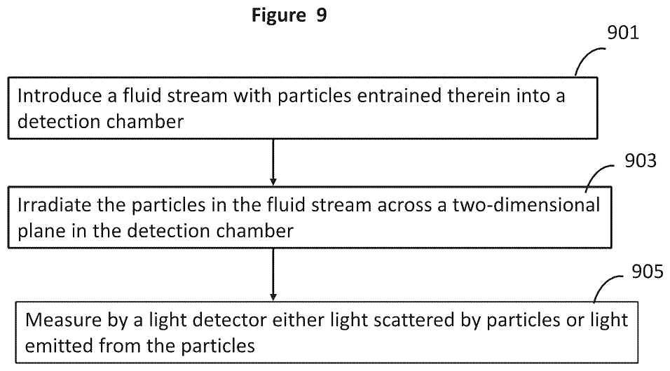

FIG. 9 is a flow chart depicting one method embodiment of the present disclosure for analyzing particles in a fluid stream. At 901, the method introduces a fluid stream with particles entrained therein into a detection chamber. At 903, the method irradiates the particles in the fluid stream across a two-dimensional plane in the detection chamber. At 905, the method measures by a light detector either a) light scattered by particles or b) light emitted from the particles.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

1. A particle detector system for particle analysis, comprising:
a detection chamber for introduction of a fluid stream having particles;
a light source configured to irradiate the particles across a two-dimensional plane in the detection chamber;
a light detector configured to detect either light scattered by particles or light emitted from the particles.

2. The particle detector system of claim 1, wherein the two-dimensional plane extends angularly across the detection chamber.

3. The particle detector system of claim 1, wherein the light detector is disposed off axis of the two-dimensional plane.

4. The particle detector system of claim 1, wherein the light source comprises a laser and optics configured to irradiate the particles along the two-dimensional plane.

5. The particle detector 1 system of claim 1, wherein the light source comprises a line laser configured to irradiate the particles along the two-dimensional plane.

6. The particle detector system of claim 1, wherein the light detector is disposed underneath the two-dimensional plane.

7. The particle detector system of claim 1, wherein the light detector is disposed above the two-dimensional plane.

8. The particle detector system of claim 1, wherein the fluid stream is passive, whereby the fluid stream is introduced into the detection chamber by motion of the particle detector.

9. The particle detector system of claim 1, further comprising a processor for communicating results from the light detector to a remote site.

10. The particle detector system of claim 1, further comprising a processor for communicating results from the light detector to a remote site.

11. The particle detector system of claim 10, wherein the detection chamber is one component of a drone.

12. The particle detector system of claim 10, wherein the detection chamber is one component of a network of sensors.

13. The particle detector system of claim 1, wherein the fluid stream is a gas stream, and the particles in the gas stream comprise at least one of aerosol particles and smoke particles.

14. The particle detector system of claim 1, wherein the fluid stream is a gas stream, and the particles in the gas stream comprise toxic particles.

15. The particle detector system of claim 1, wherein the fluid stream is a liquid stream, and the particles in the liquid stream comprise bacterial particles.

16. The particle detector system of claim 1, wherein the fluid stream is a liquid stream, and the particles in the liquid stream comprise viral particles.

17. The particle detector system of claim 1, wherein the fluid stream is a liquid stream, and the particles in the liquid stream comprise waste water particles.

18. The particle detector system of claim 1, wherein the fluid stream is a liquid stream, and the particles in the liquid stream comprise solids after water filtration.

19. A method for analyzing particles in a fluid stream, comprising:
providing a fluid stream with particles entrained therein;
irradiating the particles in the fluid stream across a two-dimensional plane; and
measuring light scattering or autofluorescence from the particles in the fluid stream.

20. A detection chamber for analyzing particles, comprising:
a light source configured to irradiate across a two-dimensional plane in the detection chamber; and
a light detector configured to measure either light scattered by or light emitted from particles in a fluid stream in the two-dimensional plane.
